(19) United States
(12) Patent Application Publication
(10) Pub. No.: US 2025/0033311 A1
(43) Pub. Date: Jan. 30, 2025

(54) MACHINE FOR MAKING PACKAGES FOR LIQUID OR PASTY PRODUCTS AND THE RELATIVE METHOD FOR MAKING PACKAGES

(71) Applicant: I.M.A. INDUSTRIA MACCHINE AUTOMATICHE S.p.A., Ozzano Dell'Emilia (Bologna) (IT)

(72) Inventors: Massimo BATTAGLIA, Ozzano Dell'Emilia (Bologna) (IT); Pierluigi CASTELLARI, Ozzano Dell'Emilia (Bologna) (IT); Dario REA, Ozzano Dell'Emilia (Bologna) (IT)

(21) Appl. No.: 18/717,048

(22) PCT Filed: Dec. 6, 2022
(86) PCT No.: PCT/IB2022/061838

§ 371 Date: Jun. 6, 2024

(30) Foreign Application Priority Data
Dec. 13, 2021 (IT) 102021000031115

(51) Int. Cl. B31B 50/10; B31B 50/16; B65B 1/02

(52) U.S. Cl. CPC B31B 50/10; B31B 50/16; B65B 1/02

(57) ABSTRACT

Described is a method for making openable packages for a food product in liquid or pasty form comprising the steps of: feeding a continuous film (1); cutting the continuous film (1) to form a plurality of single sheets (2) and forming on each single sheet (2) crease lines designed to define fold lines for forming a container; preparing an element (3) rotating about an axis (3X) of rotation and equipped with a plurality of forming mandrels along its circumference; coupling the single sheet (2) to a forming mandrel (4) in a first predetermined angular position of rotation of the forming mandrel (4); folding the single sheet (2) around the forming mandrel (4) using folding devices (5-8) configured to wrap the single sheet (2) on the forming mandrel (4), folding it along the crease lines, in such a way as to create a bottom (2f) and front walls (2a, 2B) and side walls (2c, 2d) when the sheet is coupled with the forming mandrel (4); performing a partial sealing of the single sheet (2) folded on the forming mandrel (4), in such a way as to obtain a container open only on an end side, positioned opposite the closed bottom (2f), with an opening (2e) for access to an inner cavity; transferring the open and partly sealed container from the forming mandrel (4) to a conveyor device (9); filling with the food product the cavity of the open container through the access opening (2e), and, upon completion the filling, completely closing the container by final sealing of the access opening (2e), in such a way as to make a sealed openable container.

### TECHNICAL FIELD

This invention relates to a machine for making packages with a prismatic shape for liquid or pasty products, in particular of the food type.

The invention also relates to a method for making packages containing the above-mentioned liquid or pasty products.

### BACKGROUND ART

In this description, reference is made for liquid or pasty products to products which can be fed into the package by a nozzle, both when cold and when hot, such as, for example, consisting of processed cheese, butter, chocolate, marmalade, etc.

Generally speaking, this type of package has two blanks, one for forming the container and the other for forming the lid which, after filling the container, is placed on the product poured into the container and it is all then sealed.

There are therefore some requirements for the production of packages for pasty products in which it is necessary to have:
packages which can also be made from paper-based material and which can equally guarantee an optimum insulating seal and the absence of empty spaces inside for an acceptable shelf life;
a machine with reduced overall dimensions coupled with a high flexibility which allows the shape of the final package to be easily changed, by way of example prismatic with a quadrangular or triangular cross-section.

There are prior art methods and machines for forming packages starting from a blank which is gradually folded to form the package.

Patent document GB 2 124 140 illustrates a method and a machine wherein a starting blank is folded on a first group of forming mandrels positioned along a plane, forming tubular elements open on both ends, which are then subsequently inserted in a second group of mandrels positioned on a wheel to form a bottom and a partial sealing.

Patent document WO2010/044025 describes a machine wherein a starting blank is folded forming tubular elements open on both ends, which are sent to two wheels of mandrels: a neck is inserted in the first wheel, the bottom is created in the second wheel.

### DISCLOSURE OF THE INVENTION

The aim of the invention is to provide a machine for production of packages for liquid or pasty products, in particular food products, which overcome the above-mentioned drawbacks of the prior art.

The aim of the invention is to provide a method for making packages containing the above-mentioned liquid or pasty food products.

In particular, the aim of the invention is to provide a machine and a method for making packages for liquid or pasty products which is able to obtain a package in a short operating time and with reduced machine overall dimensions.

A further aim of the invention is to provide a machine and a method for making packages for liquid or pasty products which is able to obtain a package with regular geometry starting from a single blank, maintaining a high final quality of the product.

Said aims are fully achieved by the machine and method for making packages package for liquid or pasty products according to the invention as characterised in the appended claims.

### BRIEF DESCRIPTION OF DRAWINGS

The features of the solution according to the invention will become more apparent from the following detailed description of a preferred, non-limiting embodiment of it, with reference to the accompanying drawings, in which:

FIG. 1 is a schematic front view, with some parts cut away to better illustrate others, of a machine for making packages for liquid or pasty products according to the invention, implementing the method for making packages for liquid or pasty products, again according to the invention;

FIG. 2a is a schematic top view of a station for forming a first format of flat sheets of continuous film for the subsequent definition of the package forming part of the machine of FIG. 1;

FIG. 2b is a schematic top view of a station for forming a second format of flat sheets of continuous film for the subsequent definition of the package forming part of the machine of FIG. 1;

FIG. 3 is a partial perspective view of a part of a rotary element equipped with forming mandrels forming part of the machine of FIG. 1 and in a first operating configuration of a forming mandrel fed by a first format of flat sheet of FIG. 2a;

FIG. 4 is a perspective view of a rotary element equipped with forming mandrels forming part of the machine of FIG. 1 and in a second operating configuration of a forming mandrel fed by a first format of flat sheet of FIG. 2a;

FIG. 5a is a schematic perspective view of an arrangement for forming the package starting from the first format of single sheet of FIG. 2a and obtained with the machine and the method according to the invention;

FIG. 5b is a perspective view of an enlarged detail of FIG. 5a referred to the formation of the bottom of the package;

FIG. 6a is a schematic perspective view of an arrangement for forming the package starting from the second format of single sheet of FIG. 2b and obtained with the machine and the method according to the invention;

FIG. 6b is a schematic perspective view of an arrangement for forming the package starting from the second format of single sheet of FIG. 2b and obtained with the machine and the method according to the invention;

FIG. 7 is a perspective view of a detail of the machine of FIG. 1 showing the rotary element and a first folding/sealing station in a first non-operating configuration;

FIG. 8 is a perspective view of a detail of the machine of FIG. 1 showing the rotary element and a first folding/sealing station in a second operating configuration;

FIG. 9 is a perspective view of a further detail of the machine of FIG. 1 showing the rotary element and a second folding/sealing station in an operating configuration;

FIGS. 10A to 10E are perspective views of a further station for folding/sealing the bottom of the package in a succession of steps to obtain the closed and sealed bottom of the package starting from the first format of the sheet;

FIG. 11 is a perspective view, with some parts cut away, of another operating zone of the machine of FIG. 1, comprising the rotary element and a unit for unloading and transporting the open packages formed on the mandrels;

FIG. 12 is a scaled-up perspective view, with some parts cut away to better illustrate others, of a detail of FIG. 11;

FIG. 13 is a perspective view of a variant embodiment of the rotary element equipped with forming mandrels forming part of the machine of FIG. 1.

### DETAILED DESCRIPTION OF PREFERRED EMBODIMENTS OF THE INVENTION

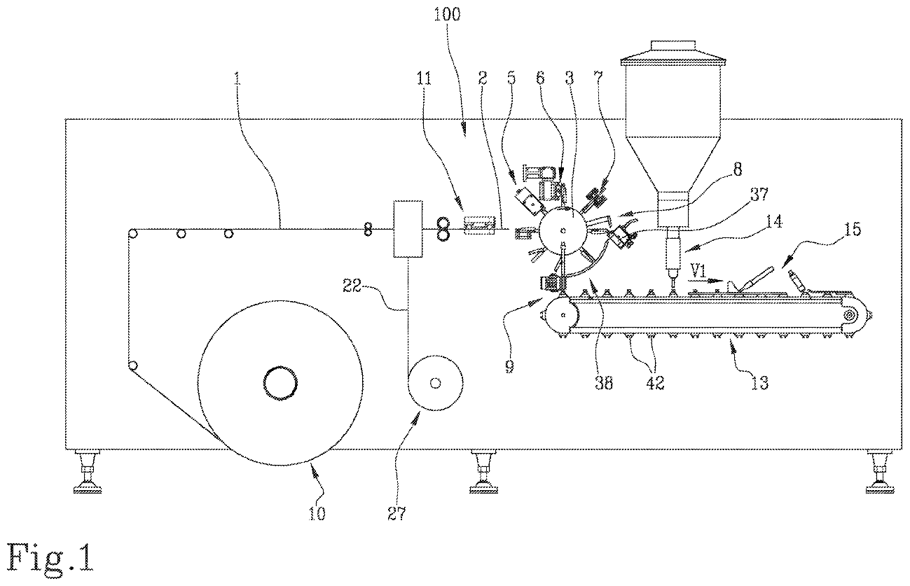

With reference to the accompanying drawings, in particular FIG. 1, the method and the machine according to the invention, labelled 100 in its entirety, are used for making packages with a food product in a liquid or pasty form (for example, but without limiting the scope of the invention, food products such as processed cheese, butter, chocolate, jams, etc.).

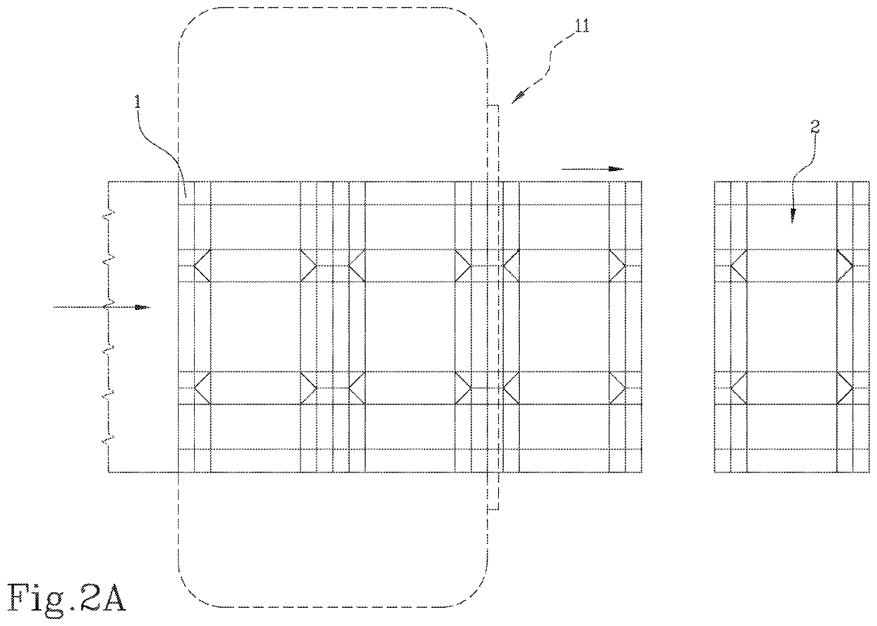

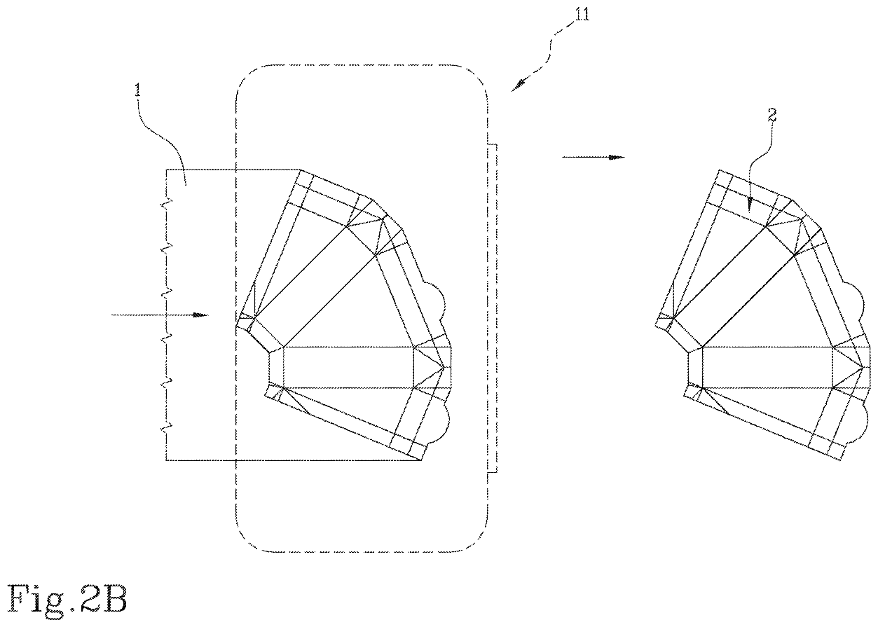

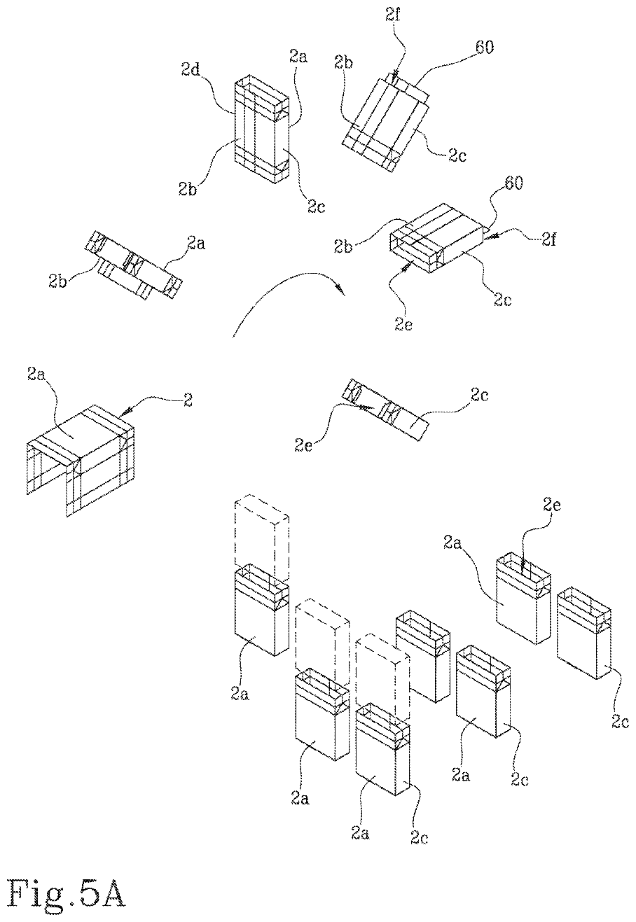

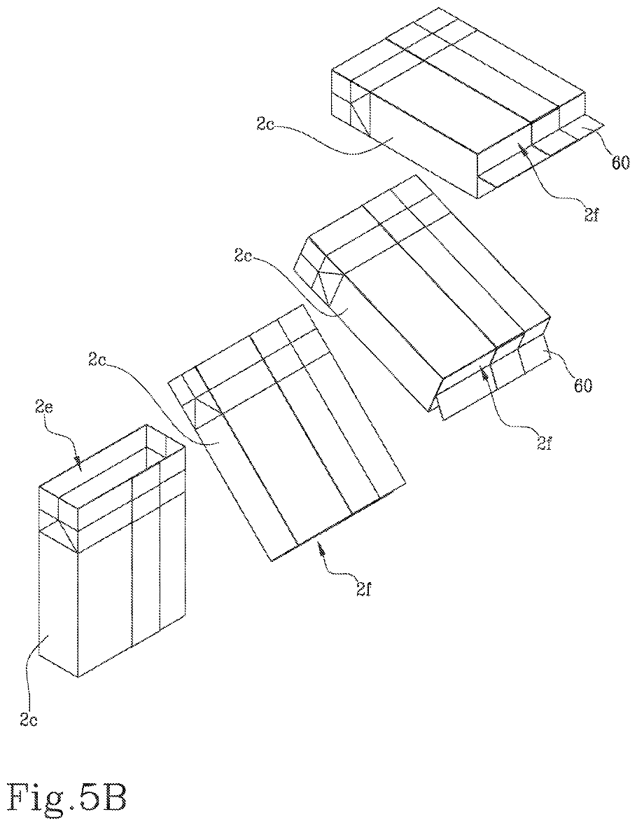

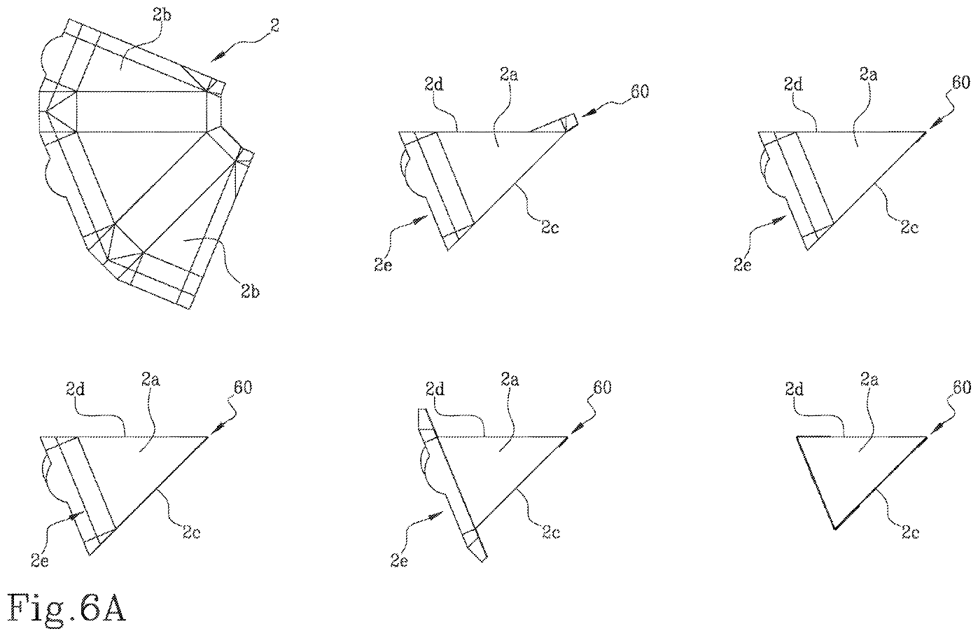

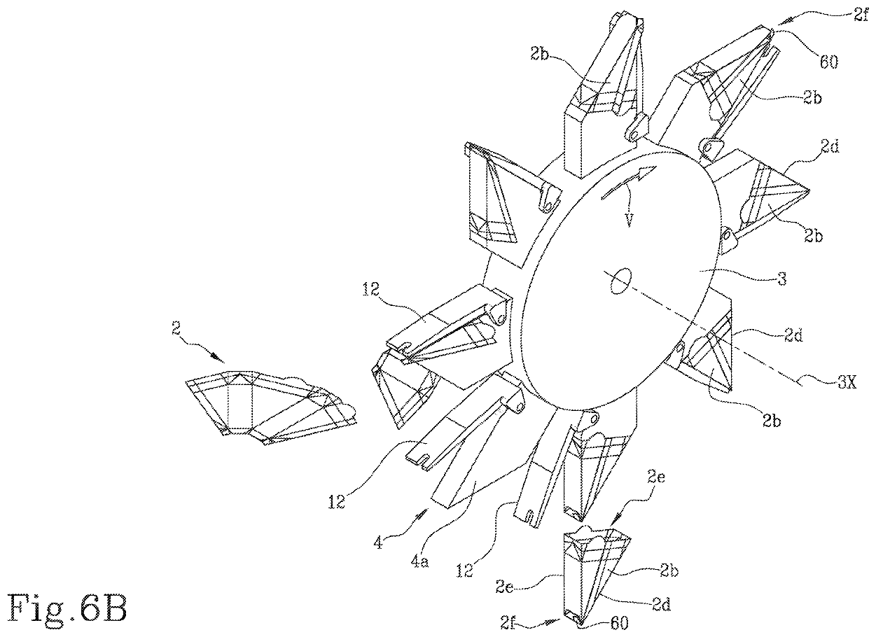

FIGS. 2a, 5a and 5b show a first format of the single sheet from which the parallelepiped package is obtained, whilst FIGS. 2b, 6a and 6b show a second format of the single sheet from which to obtain a second type of package having a triangular prismatic shape, that is to say, having two triangular front walls opposite and parallel to each other, two opposite rectangular side walls inclined towards a common vertex, and a substantially rectangular bottom wall from whose larger opposite edges the two front walls extend, whilst the two side walls extend from the two smaller opposite edges. The substantially rectangular bottom wall could also have a slight curvature.

For simplicity of description, since most of the steps of the method and of the machine parts are in common, only the variants (always starting from the first format of the sheet) will be highlighted in order to confirm the flexibility and validity of the method and of the machine according to the invention.

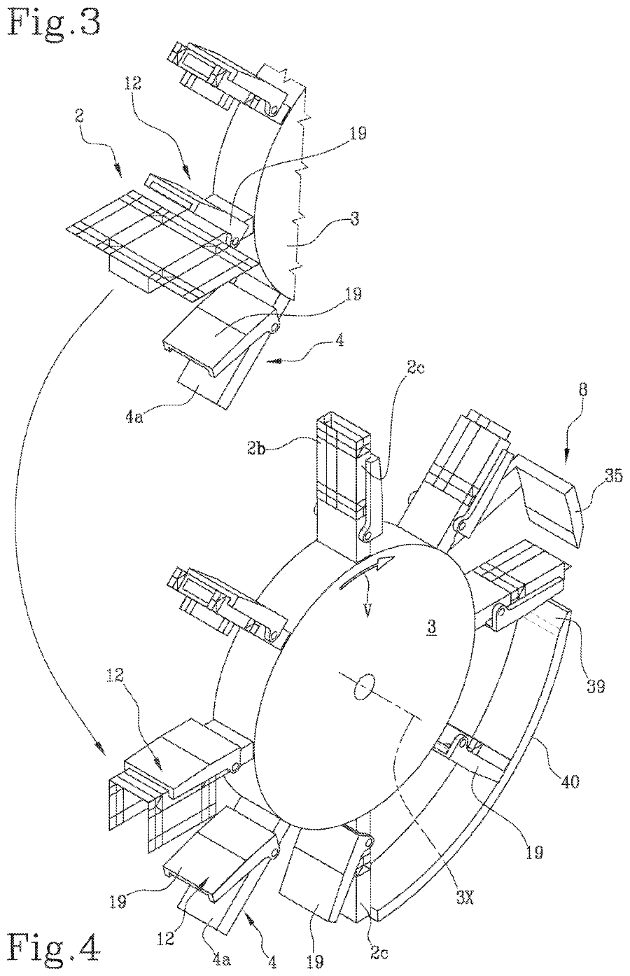

As illustrated, the method for making packages with a food product comprises the steps of:
feeding a continuous film 1 (FIG. 1);
cutting the continuous film 1 to form a plurality of single sheets 2 and to make on each sheet 2 single crease lines designed to form fold lines for forming a container (FIG. 2a or 2b); the crease lines are created whilst the sheet 2 is in a substantially flat configuration;
preparing an element 3 rotating about an axis 3X of rotation and equipped with a plurality of forming mandrels 4 along its circumference (FIGS. 3 and 4).

Each forming mandrel 4 has a prismatic shape which extends radially.

The method also comprises:
coupling the single sheet 2 to a forming mandrel 4 of the plurality of forming mandrels in a first predetermined angular position of rotation of the forming mandrel 4, positioning the single sheet 2 with at least one face in contact with the forming mandrel 4 (see FIGS. 3 and 4);
folding the single sheet 2 about the forming mandrel 4 using folding devices 5-8 configured to wrap the single sheet 2 on the forming mandrel 4, folding it along the crease lines, in such a way as to create a bottom 2f and two opposite front walls 2a, 2b and two opposite side walls 2c, 2d when the sheet 2 is coupled with the forming mandrel 4 (see FIG. 5a or 6a);
partially sealing the single sheet 2 folded on the forming mandrel 4, so as to obtain an open container which is opened only on an end side, arranged opposite the closed bottom 60, with an access opening 2e to an internal cavity closed by the front and side walls 2a, 2b, 2c, 2d and by the bottom 2f (see FIG. 5b or 6b).

It should be noted that the bottom 2f is formed on the forming mandrel 4 at a distal end of the forming mandrel 4, that is to say, at a distance from the axis of rotation 3X greater than the distance between the axis 3X of rotation and the access opening 2e.

When the container has the shape of a parallelepiped, the bottom is a rectangular wall, whilst when the container is triangular, the bottom, according to the invention, consists of an edge on the vertex (see FIGS. 6a and 6b).

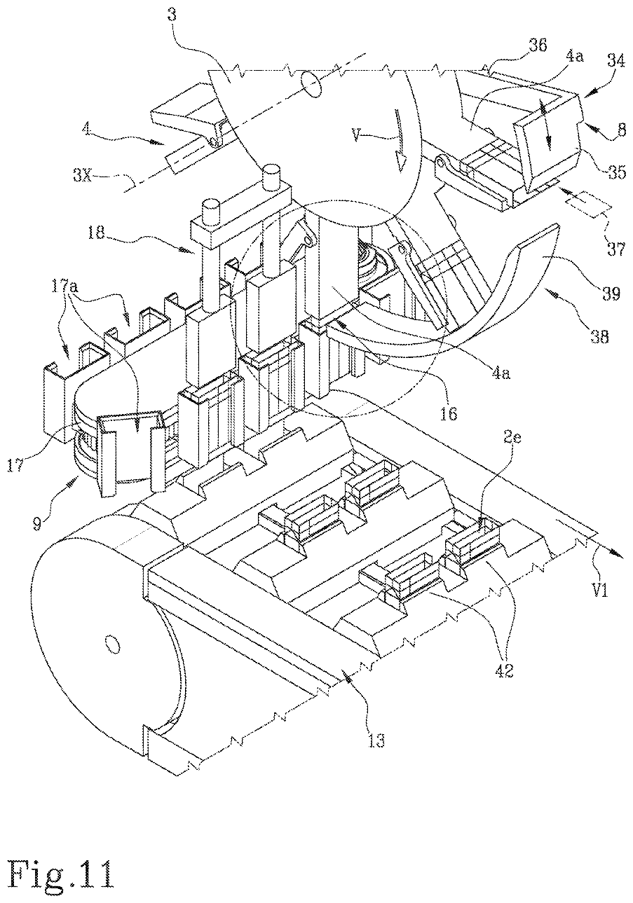

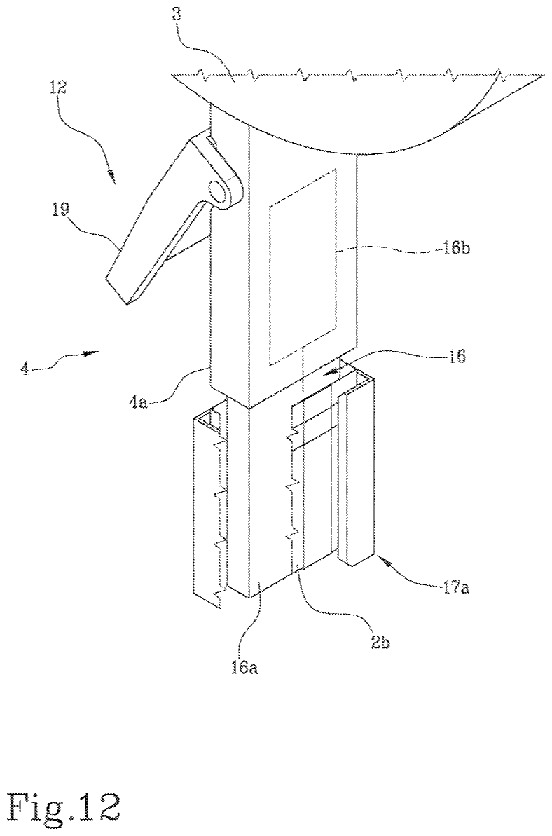

According to the invention, the method also comprises the following steps:
transferring the open and partly sealed container from the forming mandrel 4 to a conveyor device 9, at a second angular position of rotation of the forming mandrel 4, different from the first angular position (see FIGS. 11 and 12);
moving, using the conveyor device 9, the open container to a filling station 14 and filling with the food product the cavity of the open container through the access opening 2e (see FIG. 1).

It should be noted that the access opening 2e is positioned upwards in such a way as to fill the open container by falling of the product.

As illustrated, the method comprises, upon completion of the filling, a step of completely closing the container by final sealing of the access opening 2e.

According to the invention, the continuous film 1 from which the single sheets 2 are obtained is made of material suitable for food use, in particular, preferably, it is a paper-based material.

More preferably, the material is formed by at least one layer of paper and a barrier layer made of material impermeable to gases.

Preferably, the step of coupling the single sheet 2 on the mandrel 4 occurs with the single sheet 2 in a flat configuration (see FIG. 3).

As illustrated, in particular in FIG. 5a or 6b, the step of folding the single sheet 2 is performed along various angular positions of rotation of the mandrel 3.

In light of this, therefore, the steps of folding the single sheet 2 all occur around the same forming mandrel 4 (except for the bottom 2f which is used for filling the product).

This allows for a sequence of rapid steps, precise for each package being formed, as well as reducing the overalls dimensions of the machine, as described in more detail below.

It should be noted that the step of coupling the single sheet 2 onto the mandrel 4 occurs with the single sheet 2 positioned horizontally.

Preferably, the step of transferring the open container from the forming mandrel 4 to the conveyor device 9 is performed by expulsion of the container from the forming mandrel 4 by pushing on the bottom 2f of the container in such a way as to slide the container on an outer surface of the forming mandrel 4 (see FIGS. 11 and 12).

Alternatively, the open and partly sealed container may be pulled out from the mandrel by means of an external system which, by suction, acting on an outer face of at least one of the walls, extracts the container from the mandrel.

In both solutions, the step of transferring the open and partly sealed container to the conveyor device 9 occurs with the container positioned vertically with the access opening 2e facing upwards and the bottom 2f facing downwards. With reference to the first embodiment shown in FIGS. 4, 5a and 5b, the folding step comprises a series of sub-steps.

A first sub-step comprises a first folding of the single sheet 2, in the first angular position of the forming mandrel 4, which is able to form a first front wall 2a, and the two opposite side walls 2c and 2d.

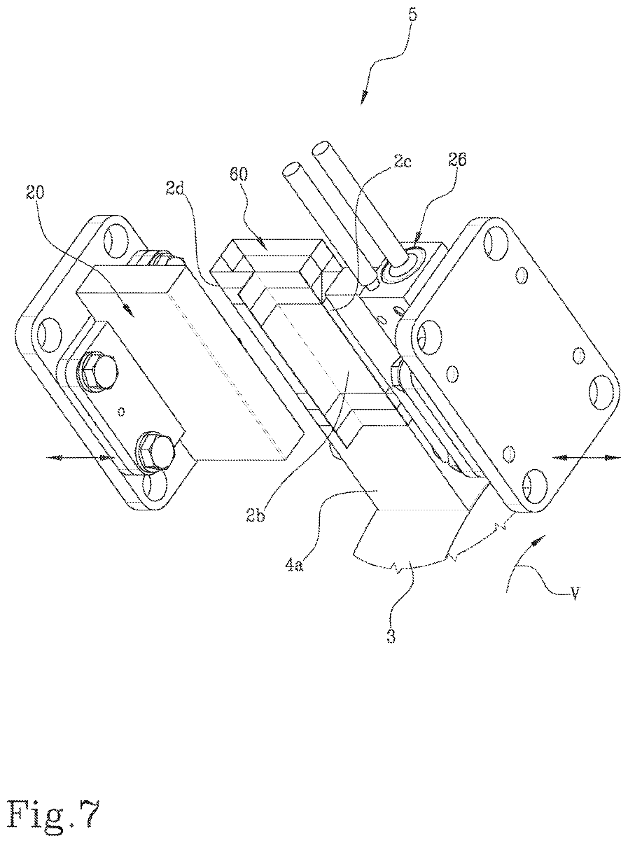

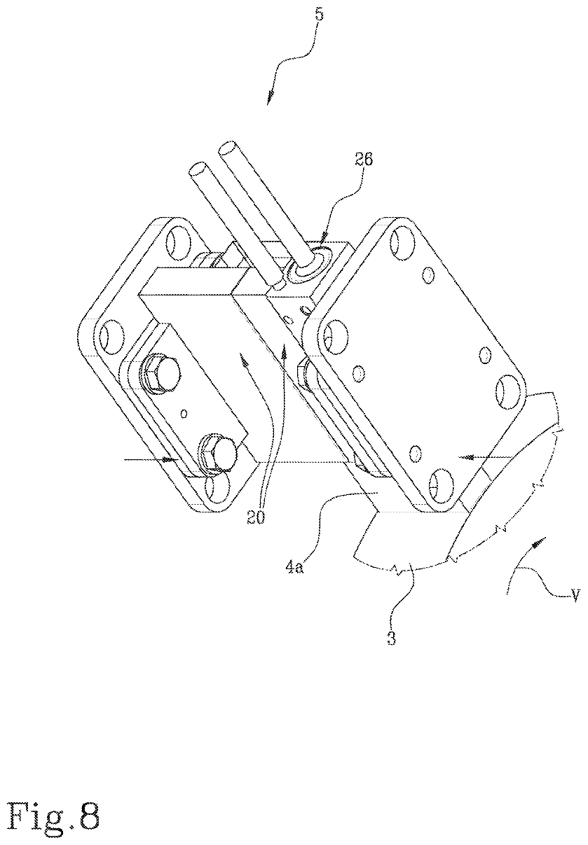

A second sub-step comprises a second folding of the single sheet 2, in a subsequent angular position of the forming mandrel 4, which is able to form a second front wall 2b, opposite the first front wall 2a, and in such a way as to bring two opposite portions against the forming mandrel 4 and respective edges in contact with each other on a respective inner face in such a way as to create a longitudinal fin (sealable by adhesion of the inner surfaces of the portions). (see FIGS. 7 and 8)

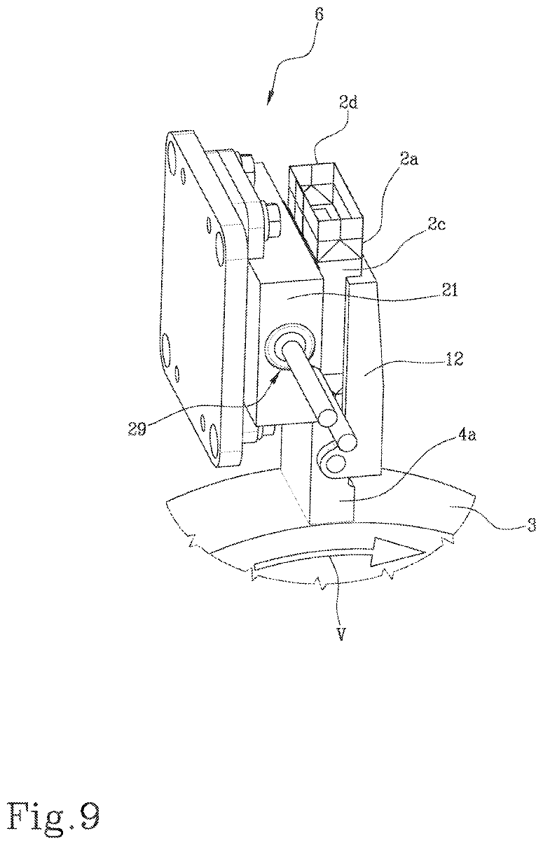

A third sub-step comprises a third folding of the single sheet 2, in a subsequent angular position of the forming mandrel 4, which is able to move the longitudinal fin into contact with an outer surface of the second front wall 2b (see FIG. 9).

During this third fold it is also possible to comprise a step of locking the longitudinal fin on the outer surface of the second front wall 2b by means of adhesive lacquer or with a peelable hot melt.

A fourth sub-step comprises a fourth folding of the single sheet 2, in further angular positions of the forming mandrel 4, at free edges of the sheet 2 not engaged by the forming mandrel 4 which is able to form the closed bottom 2f of the container (see FIG. 5b or 6b).

During this fourth folding step there is also a step of bottom sealing, transversal to the longitudinal sealing, wherein a transversal edge of the second front wall 2b is glued to a transversal edge of the first front wall 2a, this bottom sealing step is preferably performed by coupling the inner-inner walls in such a way as to form a transversely sealed fin (FIG. 5b).

As illustrated, the bottom 2f is closed by a bottom fin 60 made by stably joining two internal faces of the single sheet 2.

In light of this, the formation of the bottom fin 60 is formed, in the parallelepiped package, centrally on the bottom and protruding towards the outside of the container by simultaneously folding outer edges of the first and second front walls 2a, 2b of the single sheet 2 protruding perpendicularly from the two side walls 2c and 2d; once the bottom fin 60 has been formed, it is folded on the bottom 2f and locked in position, for example by hot melt.

FIGS. 6a and 6b illustrate a folding sequence of a triangular format wherein the first three sub-steps are substantially the same as those described above whilst the fourth sub-step in this case comprises the sealing of the bottom formed by the edge on the vertex, here the edges of the side walls are joined by coupling the inner-inner walls in such a way as to form a fin sealed transversely along the edge (see FIGS. 6a and 6b).

For both the formats of sheet 2, the second, third and fourth folding occurs in different angular positions.

In particular, at least the second and third folds occur during a respective pause of the rotary element 3.

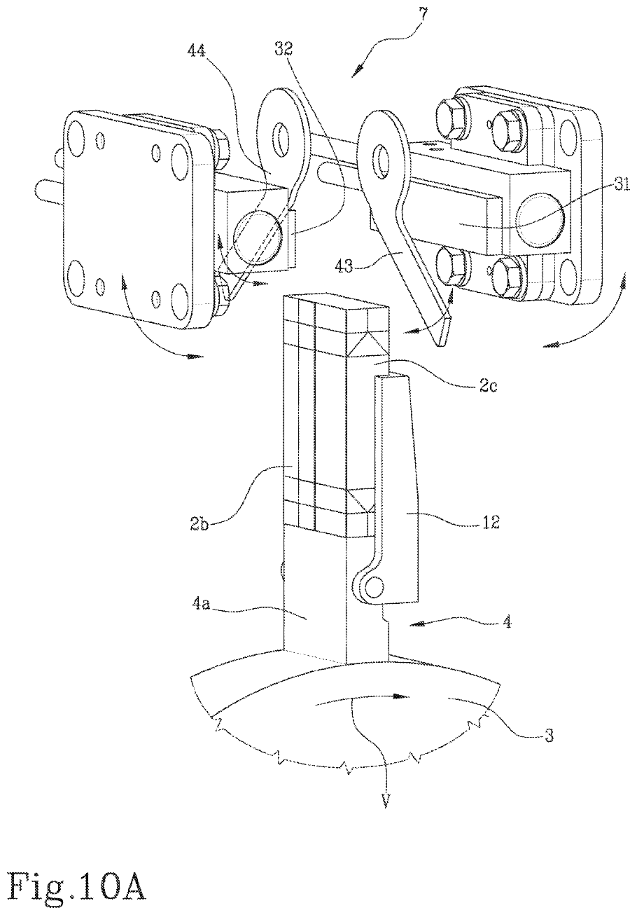

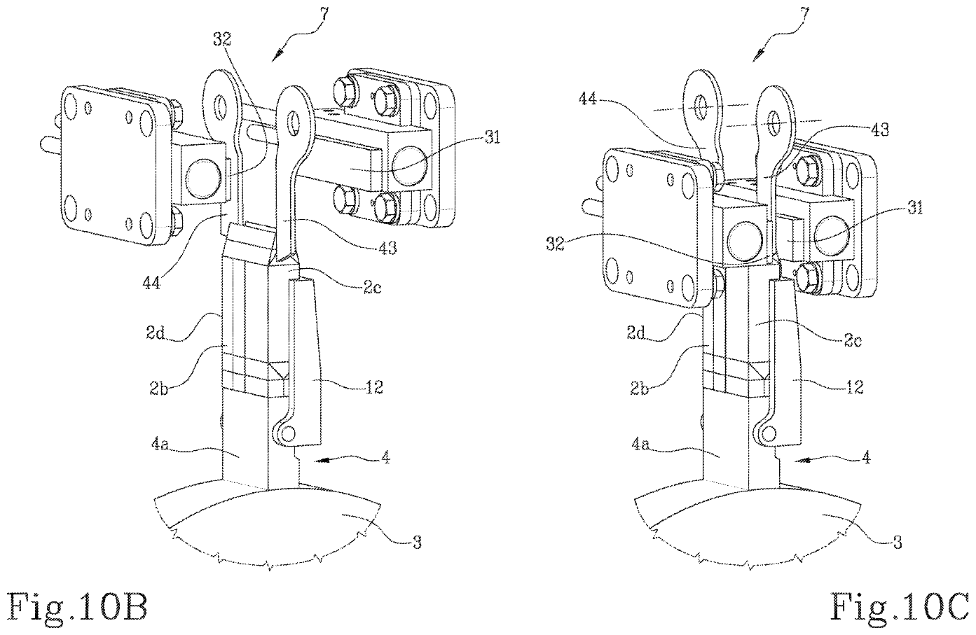

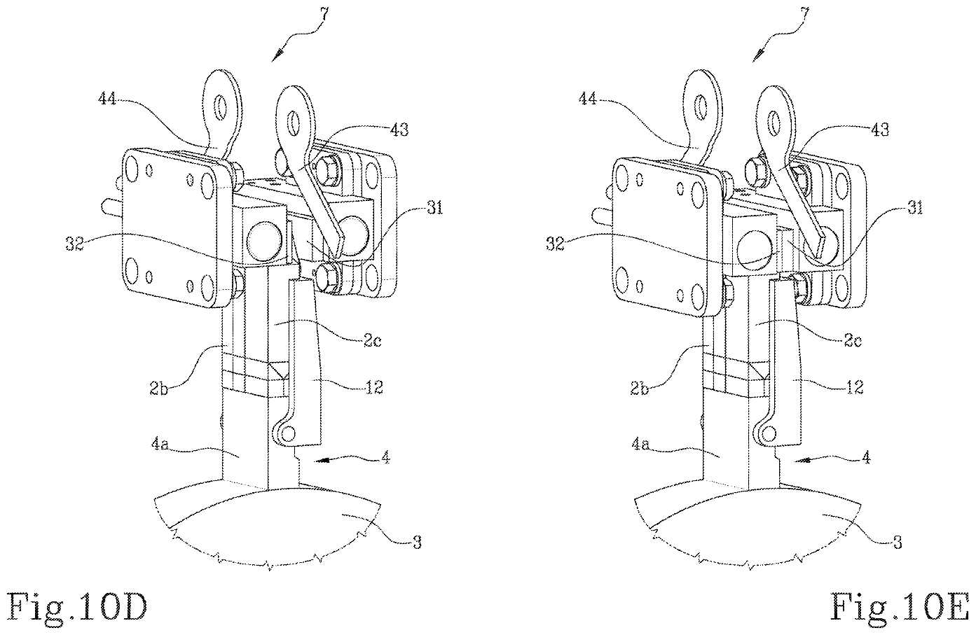

With reference to the parallelepiped embodiment, before the step of forming the bottom fin 60, there is a step of folding the sides in a concertina fashion, which are pushed towards the inside before creating the bottom fin 60 (see FIGS. 5b and 10a-10e).

It should be noted that the folding of the bottom fin 60 may be performed in the same direction as the advancement direction of the rotary element.

It should be noted between the step of feeding the continuous film 1 and the step of cutting the continuous film 1 into single sheets 2 it is possible to comprise a step of applying at least one tear strip 22 (tear strip) on the film 1 being fed forward. In light of this, the tear strip 22 may be applied on the barrier layer of material impermeable to gases.

As an alternative to the use of the tear strip it is possible to form cutting means, that is to say, to make predetermined break lines.

According to a further embodiment, non-permanent glue may be used in such a way as to be peelable from the seals.

Further, it is possible to leave unsealed zones to form suitable flaps to allow gripping to open the package.

The invention provides a machine 100 for making packages with a food product in a liquid or pasty form according to the method described above.

As illustrated in FIG. 1, the machine 100 comprises a station 10 for feeding the continuous film 1.

The machine 100 also comprises a station 11 for forming a single sheet 2, from the continuous film 1, on which crease lines are formed, designed to form fold lines for forming a container (see FIG. 2a for the first format and FIG. 2b for the second format). It should be noted that the crease lines are created whilst the sheet 2 is in a substantially flat configuration.

Moreover, the machine 100 comprises an element 3 rotating about an axis 3X of rotation (a carousel) and provided with a plurality of forming mandrels 4 protruding radially along the circumference of the rotary element 3 and configured to receive, each forming mandrel 4, a single sheet 2 in a flat configuration from the forming station 11 in a first predetermined angular position (for example, at 9 o'clock).

Each forming mandrel 4 is equipped with a device 12 for folding/retaining the single sheet 2 on the forming mandrel 4 configured to retain and form at least a first front wall 2a.

The machine 100 also comprises a plurality of folding/sealing stations 5-8, 38 positioned along a circular path travelled by the forming mandrels 4, and interacting with each forming mandrel 4 of the rotary element 3, in such a way as to completely wrap the single sheet 2 on the respective forming mandrel 4, folding it along the crease lines, in such a way as to create pairs of side walls 2c, 2D and front walls 2a, 2b mutually opposite each other and a bottom 2f stably joined together to form a container open only on one end side.

The machine 100 also comprises a conveyor device 13 positioned in a second predetermined angular position of rotation of the forming mandrel 4 (for example, at 6 o'clock), different from the first angular position and configured to receive the open containers, after being formed on the respective forming mandrel 4, only on an end side, and for moving them towards a filling station 14.

The filling station 14 configured to feed the open containers, by falling, with product into a cavity of the open container through an access opening 2e defined by the open end, and subsequently towards a station 15 for sealing the access opening 2e of the container.

In FIG. 1, the feed station 10 is a continuous roll of film fed along a predetermined path to the station 11 for forming the single sheet 2.

The roll is unrolled in such a way as to advance the sheet perpendicularly to the axis of rotation 3X and horizontally (as in FIG. 3) or vertically, however it is possible to advance the sheet to be folded in a direction parallel to the axis of rotation 3X, either horizontally or vertically.

The machine 100 may also comprise at least one additional reel 27 for feeding and applying at least one tear strip 22 on the film 1 being fed forward.

In light of this, the tear strip 22 is applied on the barrier layer of material impermeable to the gases of the continuous film.

Alternatively, in order to facilitate the opening of the container, cutting means may be formed on the single sheet, that is to say, forming predetermined break lines without loss of seal of the single sheet, or the use of non-permanent glue, in such a way as to be easily peelable.

It should be noted that each forming mandrel 4 comprises a prismatic body 4a sized for making the two front and side walls 2a-2d, respectively, and the bottom 2f of the container.

It should be noted that each forming mandrel 4 comprises an ejection device 16 configured to pull the container out from the forming mandrel 4 pushing into the cavity against an inner face of the bottom 2f of the container. In light of this, each mandrel 4 is provided with the ejection device 16 (FIG. 12) comprising a pushing head 16a connected to movement means 16b (illustrated schematically) configured for moving the pushing head 16a between a non-operating position, wherein the head 16a is inside the forming mandrel 4, and an operating position, wherein the head 16a protrudes from the forming mandrel 4, in such a way as to pull the container out from the prismatic body 4a pushing against the bottom 2f of the container (see FIGS. 11 and 12).

In other words, the prismatic body 4a is hollow and houses the head 16 connected, on the inner end, with cam means interacting with the rotary element 3 to allow the sliding in both directions of the head 16.

Alternatively, the ejection device may be outside the forming mandrel and pass through the inside of the forming mandrel only when the latter reaches the second angular position of rotation, where the package is extracted.

Alternatively, for the use of the ejection device 16, it is possible to use a common system, not illustrated, which positioned close to the second predetermined angular position, by suction, acting on an outer face of a wall of the container, extracts the container from the mandrel 4, when the latter reaches the second angular position.

As mentioned above, each forming mandrel 4 supports a folding/retaining device 12 comprising a folding arm 19 articulated to the corresponding forming mandrel 4 and movable between a raised non-operating position, wherein the folding arm 19 is moved away from a surface of the forming mandrel 4, and an operating position, wherein the folding arm 19 is moved towards the surface of the forming mandrel 4 with the single sheet 2 interposed.

The folding arm 19 is configured in such a way as to block and at least partly fold the single sheet 2 on the forming mandrel 4 (see FIG. 4).

The machine 100 comprises a track 17 rotating along a closed path, positioned and configured to temporally receive the open containers which have been pulled out from the forming mandrels 4 and move them to the conveyor device 13 (see FIG. 11).

In light of this, the track 17 is provided with receiving seats 17a positioned equidistant (from the open pockets below and above) and configured to receive single open containers.

The containers are received, with the respective opening facing upwards, from an upper opening of the receiving seat 17a and expelled from an opposite lower opening of the receiving seat 17a.

Above the track 17 (laterally relative to the rotary element 3) there is an ejection device 18 configured to operate in conjunction with the receiving seats 17a in such a way as to move the open containers from the track 17 to the conveyor device 13 according to a vertical movement.

In the configuration illustrated, the ejection device 18 is able to expel two open containers at a time from two adjacent receiving seats 17a and move them into respective pockets 42 of the conveyor device 13, which is described in more detail below.

As an alternative to the use of a track, it is possible to provide other types of closed transport systems, such as, for example, a race track system.

As may be seen in FIGS. 7 and 8, one of the folding/sealing stations 5 (for the first format of the sheet) comprises a first pair of folding heads 20 positioned on both sides relative to the circular path of each forming mandrel 4 and movable, in both directions, parallel to the axis 3X of rotation of the rotary element 3 between a withdrawn non-operating position (FIG. 7), wherein the first pair of heads 20 are moved away from the forming mandrel 4, passing along the circular path, and an advanced operating position (FIG. 8), wherein the first pair of heads 20 is close to the forming mandrel 4, during a step of pausing the forming mandrel 4, in such a way as to intercept a part of the single sheet 2 and obtain its folding to form the pair of front walls 2a, 2b opposite each other of the container and forming a longitudinal fin made by stably joining two inner faces of the single sheet 2. In this case, the longitudinal fin is positioned radially relative to the rotary element 3. According to the example illustrated, the folding station 5 is at 11 o'clock relative to the position of the forming mandrel 4.

Sealing means 26 (hot or ultrasound) are housed on at least one of the folding heads 20 which are able to stabilise the joining between the two portions defining the longitudinal fin.

The joining between the two portions occurs inside it in such a way as to create the longitudinal sealing fin.

During the sealing with the sealing means 26, the longitudinal fin is positioned perpendicularly to the front walls 2a, 2b.

The other folding/sealing station 6 acts on the longitudinal fin formed (both in the first and the second format of the sheet).

As shown in FIG. 9, the folding/sealing station 6 comprises a second folding head 21 positioned laterally relative to the circular path of each forming mandrel 4 and movable, in both directions, parallel to the axis of rotation 3X of the rotary element 3 between a withdrawn non-operating position (not illustrated), wherein the second head 21 is away from the forming mandrel 4, in transit along the circular path, and an advanced operating position (FIG. 9), wherein the second head 21 is close to the forming mandrel 4, during a step of pausing the forming mandrel 4, in such a way as to intercept the longitudinal fin, positioned perpendicularly to the pair of front walls 2a, 2b previously formed, and obtaining its folding on the outer surface of one of the front walls, the 2b, of container.

The second head 21 may also be provided with sealing means 29 (hot glue or ultrasonic) if the longitudinal fin is to be stably associated on the outer surface of the second front wall 2b.

According to the parallelepiped embodiment, the bottom 2f of the open container is closed in a station 7 for sealing the bottom 2f positioned along the circular path of each forming mandrel 4, after the folding station 6.

The station 7 for sealing the bottom 2f comprises two opposite sealing plates 31, 32 configured to intercept and simultaneously fold the outer edges of the front walls 2a, 2b of the single sheet 2 so as to form a bottom fin 60 protruding towards the outside of the container (see FIG. 5B).

The two plates 31 and 32 move towards and away from the edges of the container by a roto-translational movement in both directions (see arrows in FIG. 10A).

In particular, the sealing station 7 also comprises a pair of folding blades 43 and 44 positioned facing the corresponding outer edges of the two side walls 2c, 2d and rotatable about a relative axis transversal to the axis 3X of the rotary element 3.

The folding blades 43 and 44 move between a first non-operating position away from the outer edges of the two side walls 2c, 2d (see FIG. 10A) to a second operating position close to the lateral edges of the two walls 2c, 2d before the two plates 31 and 32 are moved towards each other (see FIGS. 10B and 10C).

During this movement, the two blades 43 and 44 intercept the lateral edges and fold the outer edges of the side walls 2c, 2d towards the inside of the space of the package in a concertina fashion.

After folding, the two blades 43 and 44 rotate in the opposite direction away from the folded lateral edges so as to leave space for the two plates 31 and 33, which form the bottom fin 60 (see FIGS. 10d and 10e).

Downstream of the sealing station 7 there are folding and fixing stations, in particular, in succession with respect to the direction V of rotation of the rotary element 3, there are: a station 8 for folding the bottom fin 60, which comprises a device 34 for folding, at right angles of the bottom fin 60, against the bottom 2f of the container.

The folding device 34 is configured to fold the bottom fin 60, in the example illustrated in the same direction as the direction V of rotation of the rotary element 3.

The folding device 34 comprises a blade 35 associated with a lever 36 articulated to the rotary element 3.

The blade 35 is configured to fold, at a right angle, the bottom fin 60 against the bottom wall 2f.

In order to obtain this folding, the blade 35 has a rotational oscillating movement about the axis 3X combined with a radial movement, using the lever 36, in such a way as to allow a folding rotation of the bottom fin 60 and a pressure against the mandrel.

It should be noted that close to the operating zone of the blade 35 there is a first unit 37 for distributing glue on the surface of the bottom 2f before the step of folding the bottom fin 60 in such a way as to stabilise the bottom fin 60 against the surface of the bottom 2f of the container (see FIG. 11).

Again as illustrated in FIG. 11, the machine also comprises a folding station 38 located downstream of the station 8 for folding the bottom fin 60.

The folding station 38 comprises a first chute 39 with an arc-shaped extension configured to intercept and hold in position the bottom fin 60 until the zone for releasing the container on the track 17 in such a way as to consolidate the sealing.

According to the triangular configuration, the bottom fin is folded against a side wall (see FIGS. 6a and 6b).

The containers formed along the rotary element 3 are positioned on the above-mentioned conveyor 13 comprising a belt looped around pairs of pulleys in such a way as to form an active operating branch advancing along a horizontal direction V1, in the example perpendicularly to the axis of rotation 3X.

The belt 13 is equipped with pockets 42 (in pairs side by side) for housing corresponding containers.

Alternatively, the conveyor 13 may be made with independent carriages which carry one or more containers and which move autonomously along a preferably closed path by means of a movement system preferably of the magnetic type.

Along the path of the active branch, the containers encounter the filling station 14 with pasty product (vertically released dosing devices) and then the station 15 for sealing the access opening 2e through a plurality of folds of the upper edge of the container combined with distribution of glue.

In the example illustrated, the filling station comprises a hopper with a pair of nozzles under which the pair of pockets are arranged with the containers positioned upright, that is to say, with an opening upwards, for receiving a dose of product dispensed by falling.

The final sealing station 15 comprises heat sealers or ultrasonic sealers. In this case, too, the seal is formed inside-inside, forming a transversal head fin, parallel to the bottom fin 60 in the embodiment of the parallelepiped container. This head fin is then folded and fixed to the head wall opposite the bottom.

According to a preferred embodiment, the final sealing is performed in two successive steps during the filling step, wherein in succession after filling the container, a first sealing is performed, the air still present is expelled, and the final sealing is completed.

At the end of these operations, each container is picked up from the corresponding pocket 42.

It should be noted that the container formed is positioned in the pocket of the belt with the bottom 2f closed having the direction of folding of the bottom fin 60 opposite to the feed direction V1 of the belt, in this way, even in the presence of small obstacles along the path, the jamming of the sides or edges created by the folds on the bottom is avoided, which guarantees a high level of stability of the container (having an extremely light weight before filling).

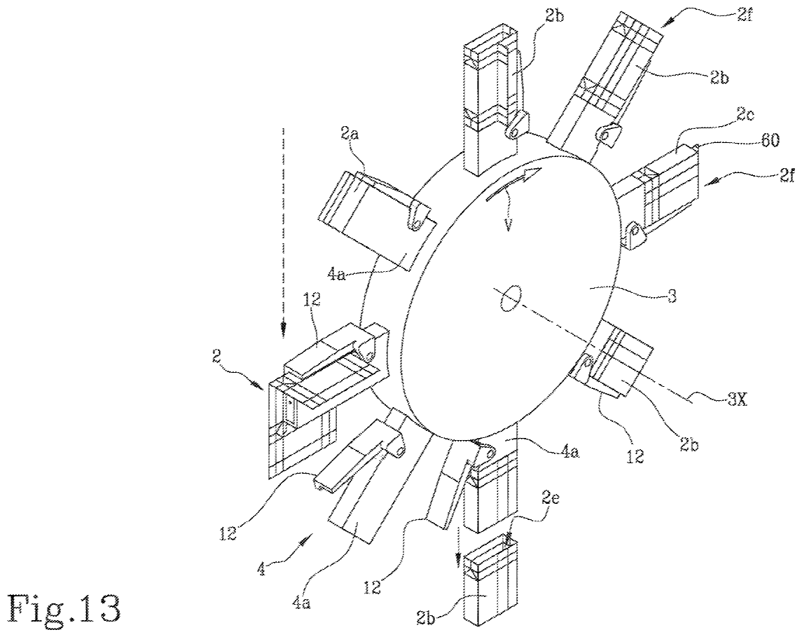

FIG. 13 shows a variant embodiment of the machine described above, confirming the validity of the solution illustrated above.

According to the case illustrated in FIG. 13, the mandrels 4 are rotated by a right angle with respect to their position illustrated in the preceding drawings.

In this case, the subsequent operations for folding and forming the container can be likened to what is described above, but with the folding stations (not illustrated) positioned according to orientations rotated by a right angle relative to the positions described above and at different positions along the path followed by the mandrels.

As mentioned above and confirming the operating flexibility of the machine, the feeding of the sheet 2 towards the rotary element 3 may occur in various ways:
according to a horizontal trajectory, that is to say, perpendicular to the axis of rotation 3X (see FIG. 3) or
according to a vertical trajectory, again perpendicular to the axis of rotation 3X (see dashed line arrow in FIG. 13), or
according to a direction parallel to the axis of rotation 3X, according to horizontal or vertical trajectories.

If the sheet 2 is fed along a vertical trajectory perpendicular to the axis of rotation 3X, a pusher element may be used configured for moving the sheet 2 towards the mandrel 4 and also determining the folding of the sheet to define the bottom 2f and the two front walls 2a, 2b of the package (or the first front wall 2a and the two side walls 2c, 2d).

After this operation it is possible to activate a retaining system which, by suction, maintains stable this first folding performed during depositing of the sheet 2 on the mandrel.

1. A method for making packages containing a liquid or pasty food product, said method comprising the following steps:
feeding a continuous film;
cutting the continuous film to form a plurality of single sheets and obtaining on each single sheet creasing lines suitable for defining folding lines for forming a container, said creasing lines being created while the single sheet is in a substantially flat configuration;
providing a rotating member which rotates about an axis of rotation and is provided with a plurality of forming mandrel along its circumference, each forming mandrel having a prismatic conformation extending radially;
coupling said single sheet to a forming mandrel of said plurality of forming mandrel at a first predetermined angular position of rotation of the rotating member;
folding the single sheet around said forming mandrel by means of folding devices configured to wrap the single sheet over said forming mandrel, folding it along the creasing lines, so as to create a bottom and two opposing frontal walls and two opposing side walls, when the sheet is coupled with said forming mandrel;
partially sealing the single sheet folded on said forming mandrel, so as to obtain on said forming mandrel an open container which is opened only on an end side arranged opposite to the closed bottom, with an access opening to an internal cavity closed by the frontal and side walls and the bottom, the bottom being formed on the forming mandrel at a distal end of the forming mandrel itself, i.e. at a distance from the axis of rotation greater than the distance between the axis of rotation and where the access opening is located;
transferring said open and partially sealed container from said forming mandrel to a conveyor device, at a second angular position of rotation of said forming mandrel, different from said first angular position;
bringing, by means of said conveyor device, said open container to a filling station e filling the cavity of the open container through the access opening with said food product, said access opening being arranged upwards so as to fill the open container with the product by dropping; and when the filling is completed,
completing the sealing of the container by final sealing of said access opening, so as to make a sealed container.

2. Method according to claim 1, wherein the step of coupling the single sheet onto the mandrel occurs with the single sheet in a flat configuration.

3. Method according to claim 1, wherein the step of folding the single sheet occurs along different angular rotational positions of the forming mandrel.

4. Method according to claim 1, wherein the step of transferring the open container from the forming mandrel to the conveyor device occurs by ejecting the open container from the forming mandrel by sliding the open container partially sealed on an outer surface of the forming mandrel.

5. Method according to claim 1, wherein the folding step comprises the following sub-steps:
a first folding of the single sheet, in the first angular position of the forming mandrel, capable of forming a first front wall, and the two side walls opposite each other;
a second folding of the single sheet, in a subsequent angular position of the forming mandrel, capable of forming a second front wall, opposite the first front wall, bringing two opposing portions against the forming mandrel and respective edges into contact with each other on a respective inner face, so as to create a longitudinal fin, arranged radially with respect to the rotating member.

6. Method according to claim 1, wherein the step of coupling the single sheet onto the mandrel takes place with the single sheet arranged horizontally.

7. Method according to claim 1, wherein the step of transferring the open and partially sealed container to the conveyor device takes place with the container arranged vertically with the access opening facing upwards and the bottom downward.

8. Method according to claim 1, wherein the bottom is closed by a bottom fin made by stably joining two internal faces of the single sheet.

9. A machine for making packages with a food product in liquid or pasty form comprising:
a feeding station for feeding a continuous film;
a forming station for forming a single sheet, from the continuous film, on which are obtained creasing lines suitable for defining folding lines for forming a container, said creasing lines being created while the sheet is in a substantially flat configuration;
a rotating member rotating about an axis of rotation and provided with a plurality of forming mandrels projecting radially along the circumference of the rotating member and configured to receive, each forming mandrel, a single sheet in a flat configuration from the forming station at a first predetermined angular position; each said forming mandrel being provided with a folding/holding device configured to hold and form at least a first wall on the forming mandrel starting form said single sheet in flat configuration;
a plurality of folding/sealing stations arranged along a circular path travelled by the forming mandrels, and interacting with each forming mandrel of said rotating member, so as to completely wrap the single sheet onto the respective forming mandrel, folding it along the creasing lines, so as to create respective pairs of side and front walls mutually opposed to each other and a bottom firmly joined together to form an open container on each forming mandrel, said container being open only on one end side;
a conveying device arranged in a second predetermined angular position of rotation of the forming mandrel, different from the first angular position and configured to receive the open containers after being formed on the respective forming mandrel and to move them towards:
a filling station configured to feed the open containers, by dropping, with product into a cavity of the open container through an access opening defined by the open end, and subsequently towards:
a sealing station for sealing the access opening of the container.

10. Machine according to claim 9, wherein each forming mandrel comprises a prismatic body dimensioned to make the respective pairs of side and front walls, and the bottom of the container.

11. Machine according to claim 9, wherein each forming mandrel comprise an ejector member configured to pull the container out of the forming mandrel by pushing within the cavity against an inner face of the bottom of said container.

12. Machine according to claim 9, comprising a track rotating around a closed path, arranged and configured to temporally receive open containers removed from the forming mandrels and bring them in the vicinity of the conveying device, said track being provided with receiving seats arranged equidistant and configured to receive individual open containers.

13. Machine according to the preceding claim 12 further comprising an ejector device configured to cooperate with said receiving seats so as to move according to a vertical movement the open containers from the track to the conveying device.

14. Machine according to claim 9, wherein each folding/holding device comprises a folding arm articulated to the corresponding forming mandrel and movable between an inoperative raised position, wherein the folding arm is moved away from a surface of the forming mandrel, and an operative position, in which the bending arm is placed close to the surface of the forming mandrel with the single sheet interposed, said bending arm being configured to fold the single sheet and form the two opposite side walls of the container.

15. Machine according to claim 9, wherein one of the bending/sealing stations comprises a first pair of bending heads arranged bilaterally with respect to the circular path of each forming mandrel and movable, bidirectionally, parallel to the axis of rotation of the rotating member between a backward inoperative position, wherein the first pair of heads are away from the forming mandrel moving along the circular path, and an advanced operative position, in which the first pair of heads are near to each other and close to the forming mandrel, in a stationary phase of the forming mandrel, so as to intercept a portion of the single sheet and folding it to form the pair of opposite front walls of the container and form a longitudinal fin made by stably joining two inner faces of the single sheet and arranged radially with respect to the rotating member.
